(19) United States
(12) Patent Application Publication
(10) Pub. No.: US 2012/0191815 A1
(43) Pub. Date: Jul. 26, 2012

(54) METHOD AND APPARATUS FOR DELIVERING TARGETED CONTENT

(75) Inventors: Nicolas Tabbal, Vienna, VA (US); Zhiqiang Bi, Washington, DC (US)

(73) Assignee: Resonate Networks, Reston, VA (US)

(21) Appl. No.: 13/348,454

(22) Filed: Jan. 11, 2012

Related U.S. Application Data
(63) Continuation-in-part of application No. 12/942,469, filed on Nov. 9, 2010.
Application No. 12/942,469 is a continuation-in-part of application No. 12/644,892, filed on Dec. 22, 2009.
(60) Provisional application No. 61/507,699, filed on Jul. 14, 2011.

(51) Int. Cl. G06F 15/16

(52) U.S. Cl. 709/218

(57) ABSTRACT

A method of selecting targeted content for delivery to a user content delivery device based on user attitude values is disclosed. Survey response information, website visitation information, television viewing information, and/or demographic information associated with the first set of users may be collected. Attitude values may be determined from the survey response information and/or other information. Attitude values may be correlated with user web visitation information, television viewing information and/or demographic information. Attitude values for a second set of user content delivery devices based on the second sets' web visitation information, television viewing information and/or demographic information are predicted. The actual and predicted attitude values may be used to select content for delivery to the first and second set of user content delivery devices.

### CROSS REFERENCE TO RELATED APPLICATIONS

The present application relates to, is a continuation in part of, and claims the benefit or earlier filed U.S. patent application Ser. No. 12/942,469 filed Nov. 9, 2010 and entitled Method And Apparatus For Delivering Targeted Content To Website Visitors To Promote Products And Brands, which relates to, and is a continuation in part of, and claims the benefit or earlier filed U.S. patent application Ser. No. 12/644,892 filed Dec. 22, 2009 and entitled Method and Apparatus for Delivering Targeted Content to Website Visitors, and relates to, and claims the priority of Provisional Patent Application No. 61/507,699, filed Jul. 14, 2011 and entitled Method and Apparatus for Delivering Targeted Content.

### FIELD OF THE INVENTION

The present invention relates to methods and apparatus for delivering content, such as advertisements, to a content delivery device associated with a device user based on predicted attitudes, values and beliefs of the device user.

### BACKGROUND OF THE INVENTION

Fiber optic cable, co-axial cable and wireless technologies such as satellite transmission, cellular service, wifi and the like, may be used to deliver content to content delivery devices of individual users. The content delivery devices may include, but not be limited to, personal computers accessed via the Internet, set top box/television set combinations which receive satellite or cable signals, and hand held devices such as cellular telephones, tablets and personal digital assistants accessed using wireless protocols. The users associated with these content delivery devices may be individual human beings, or a group of human beings, such as those who reside in a common household.

There is a need to deliver targeted content, meaning content that may be of particular interest to one or more users associated with a content delivery device, based on the users' actual and/or predicted attitudes, values and/or beliefs (collectively referred to herein as “attitudes”). Such targeted content may provide enhanced promotion of products, services, organizations, individuals, and/or brands. The ability of content providers and advertisers to deliver targeted content to users based on their actual and/or predicted attitudes has been limited. Accordingly, there is a need for improved methods and systems for delivering targeted content to users based on these factors.

It is an advantage of some, but not necessarily all, embodiments of the present invention to provide methods and systems for delivering and/or displaying targeted content to the content delivery devices associated with device users based on their actual and/or predicted attitudes. Additional advantages of various embodiments of the invention are set forth, in part, in the description that follows and, in part, will be apparent to one of ordinary skill in the art from the description and/or from the practice of the invention.

### SUMMARY OF THE INVENTION

Responsive to the foregoing challenges, Applicants have developed an innovative computer implemented method of transmitting content for viewing on a display connected to or incorporated into a content delivery device based on attitude values associated with the device, the method comprising: receiving survey response information from participating user content delivery devices; receiving features in the form of website visitation information associated with the (i) participating user content delivery devices, and (ii) non-participating user content delivery devices from which no survey response information is received; determining attitude values associated with a plurality of said participating user content delivery devices based on the survey response information; correlating the attitude values associated with the plurality of participating user content delivery devices with one or more of the features associated with the plurality of participating user content delivery devices; predicting attitude values for the non-participating user content delivery devices based on (i) one or more features associated with the non-participating user content delivery devices and (ii) the correlation of attitude values associated with the plurality of participating user content delivery devices with one or more of the features associated with the plurality of participating user content delivery devices; and delivering content to one or more of the non-participating user content delivery devices based on the predicted attitude values.

Applicants have developed an innovative computer implemented method of transmitting content for viewing on a display connected to or incorporated into a content delivery device based on attitude values associated with the device, the method comprising: receiving survey response information from participating user content delivery devices; receiving features in the form of television viewing information, website visitation information, page classification information, demographic information which is associated with the (i) participating user content delivery devices, and (ii) non-participating user content delivery devices from which no survey response information is received; determining attitude values associated with a plurality of said participating user content delivery devices based on the survey response information; correlating the attitude values associated with the plurality of participating user content delivery devices with one or more of the features associated with the plurality of participating user content delivery devices; predicting attitude values for the non-participating user content delivery devices based on (i) one or more features associated with the non-participating user content delivery devices and (ii) the correlation of attitude values associated with the plurality of participating user content delivery devices with one or more of the features associated with the plurality of participating user content delivery devices; and delivering content to one or more of the non-participating user content delivery devices based on the predicted attitude values.

Applicants have further developed an innovative computer implemented method of transmitting content for viewing on a display connected to or incorporated into a content delivery device based on attitude values associated with the device, the method comprising: receiving survey response information from participating user content delivery devices; receiving features in the form of television viewing information which is associated with the (i) participating user content delivery devices, and (ii) non-participating user content delivery devices from which no survey response information is received; determining attitude values associated with a plurality of said participating user content delivery devices based on the survey response information; correlating the attitude values associated with the plurality of participating user content delivery devices with one or more of the features associated with the plurality of participating user content delivery devices; predicting attitude values for the non-participating user content delivery devices based on (i) one or more features associated with the non-participating user content delivery devices and (ii) the correlation of attitude values associated with the plurality of participating user content delivery devices with one or more of the features associated with the plurality of participating user content delivery devices; and delivering content to one or more of the non-participating user content delivery devices based on the predicted attitude values.

It is to be understood that both the foregoing general description and the following detailed description are exemplary and explanatory only, and are not restrictive of the invention as claimed.

### BRIEF DESCRIPTION OF THE DRAWINGS

In order to assist the understanding of this invention, reference will now be made to the appended drawings, in which like reference characters refer to like elements.

FIG. 1 is a schematic diagram of a network configured in accordance with a first embodiment of the present invention.

FIG. 2 is a flow chart illustrating a first method embodiment of the present invention.

FIG. 3 is a slide showing an example issue question included in an online survey and example online survey response options and response tally in accordance with an embodiment of the present invention.

FIG. 4 is a schematic diagram illustrating the information components which may be used to determine an attitude value in accordance with an embodiment of the present invention.

FIG. 5 is a chart showing examples of general engagement actions and associated weights in accordance with an embodiment of the present invention.

FIG. 6 is a chart showing examples of general engagement levels and associated descriptions in accordance with an embodiment of the present invention.

FIG. 7 is a chart showing examples of political engagement levels and associated descriptions and values in accordance with an embodiment of the present invention.

FIG. 8 is a chart showing examples of groupings of advocacy engagement actions in accordance with an embodiment of the present invention.

FIG. 9 is a chart showing examples of advocacy engagement levels and associated descriptions and values in accordance with an embodiment of the present invention.

FIG. 10 is a chart illustrating the relationship of Value Expressions, Value Orientations and Value Statements in accordance with an embodiment of the present invention.

FIG. 11 is a chart showing examples of Shopping Engagement levels and associated descriptions in accordance with an embodiment of the present invention.

FIG. 12 is a chart showing examples of Corporate Involvement levels and associated descriptions in accordance with an embodiment of the present invention.

### DETAILED DESCRIPTION OF EMBODIMENTS OF THE INVENTION

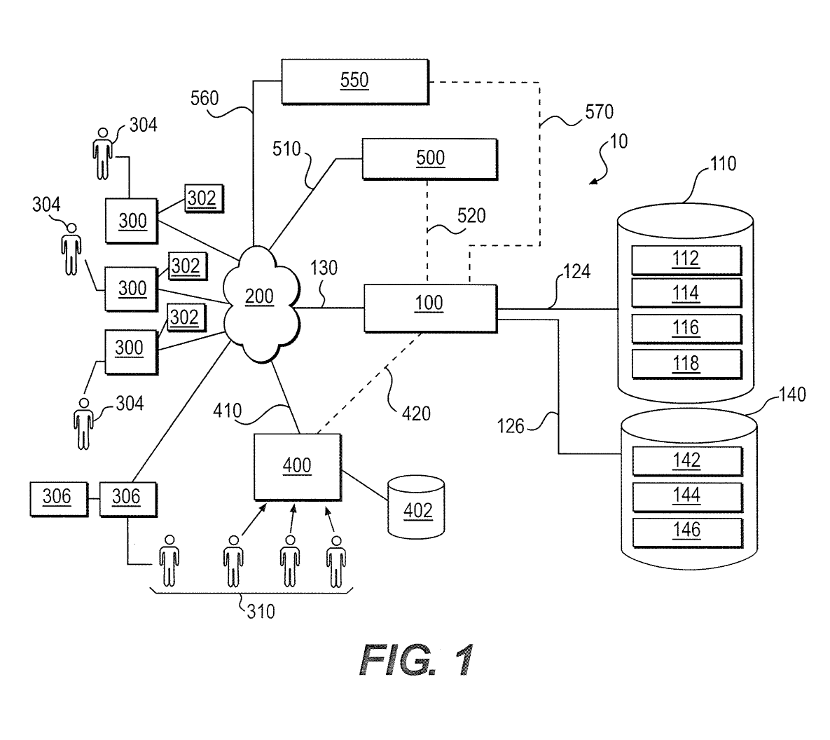

Reference will now be made in detail to a first embodiment of the present invention, an example of which is illustrated in the accompanying drawings. With reference to FIG. 1, the system 10 may include a computer 100 which may be a special use computer with permanent programming to accomplish the methods described herein, or a general use computer programmed with software to permit it to accomplish the methods described herein. The computer 100 may receive information from and store information in database 110 via a connection 124 and database 140 via a connection 126. The computer 100 may also be connected to a network 200 via a connection 130. The network 200 preferably includes, but may not be limited to, the Internet. The connections 124 and 130 may be any connection means that permit the transmission of electronic information.

The first database 110 may comprise one or more individual databases and/or database tables for storing information used by the computer 100. The information stored in the first database 110 may include survey response information 112 from participating users, demographic information 114 for participating users, participating user website visitation and/or television viewing information 116, and actual attitude value information 118 for participating users. The first database 110 may associate survey response information, demographic information, website visitation information, and actual attitude value information with an anonymous identifier for a participating user content delivery device that the information relates to.

The second database 140 also may comprise one or more individual databases and/or database tables for storing information used by the computer 100. The information stored in the second database 140 may include non-participating user demographic information 142, non-participating user website visitation and/or television viewing information 144, and predicted attitude value information 144 for non-participating users. The second database 140 may associate demographic information, website visitation information, and predicted attitude value information with an anonymous identifier for non-participating user content delivery device that the information relates to.

The network 200 may be connected to a plurality of participating content delivery devices 300 which in turn are connected to or integrated with displays 302, and which are associated with a plurality of participating content delivery device users 304. The participating device users 304 may use the participating devices 300 to access websites from one or more web servers 500 which form part of the world wide web and are connected via the network 200. Alternatively or additionally, the participating device users 304 may use the participating devices 300 to access television programming via the network 200 from a television network, cable or satellite provider 550. “Participating” devices 300 and “participating” users 304 are referred to as “participating” because each may participate in providing online and/or offline survey response information to the computer 100. Visual and audible content may be transmitted from the one or more web servers 500 and/or television providers 550 and displayed by the participating content delivery device 300 on the displays 302 for viewing and listening by the participating users 304. The network 200 may also be connected to a plurality of non-participating content delivery devices 306 which are associated with non-participating users 310.

Online survey questions stored in the first database 110 may be transmitted from the computer 100 to the participating content delivery devices 300. Participating users 304 may use their respective devices 300 to transmit online survey response information (i.e., answers to the online survey questions) over the network 200 to the computer 100. Website visitation and/or television viewing information for the participating content delivery devices 300 also may be transmitted for the participating users over the network 200 to the computer 100. In an alternative embodiment, the online survey questions may be stored in one or more of the third party databases 402 associated with one or more third party computers 400. In such embodiment, the online survey questions may be sent from the third party computers 400 to the participating users 304. Thereafter, the survey response information may be sent from the participating content delivery devices 300 to the computer 100 directly through the network 200, or alternatively through the one or more third party computers 400.

The computer 100 may also be connected to and otherwise receive information from the one or more computers 400 and associated databases or database tables 402 maintained by one or more third party data providers. The third party data provider computers 400 and associated databases or database tables 402 may store demographic information, website visitation and/or television viewing information associated with a plurality of non-participating users 310, and potentially associated with one or more of the plurality of participating users 304. The third party data provider computers 400 may receive non-participating user demographic information from non-participating content delivery devices 306 and/or from other online and/or offline sources. The non-participating user demographic information, television viewing information, website visitation information or webpage classification information may be transmitted from the third party computers 400 over a connection 410 to the computer 100, or by an alternative means 420 such as a direct electrical signal connection or via electronic information storage media.

The computer 100 may be connected to or otherwise receive information from one or more web servers 500. The web servers 500 may transmit website content over connection 510 and the network 200 to the participating user content delivery devices 300 as well as non-participating user content delivery devices 306 and displays associated with the non-participating users 310. Website visitation information also may be transmitted to the computer 100 from the web servers 500 over the network 200, or by an alternative means 520 such as a direct electrical signal connection or via electronic information storage media.

The computer 100 may be further connected to or otherwise receive information from one or more television network, cable and/or satellite providers 550. The television providers 550 may transmit television content over connection 560 and the network 200 to the participating content delivery devices 300 and 306. Television viewing information may be transmitted to the computer 100 from the television providers 550 over the network 200, or by an alternative means 570 such as a direct electrical signal connection or via electronic information storage media.

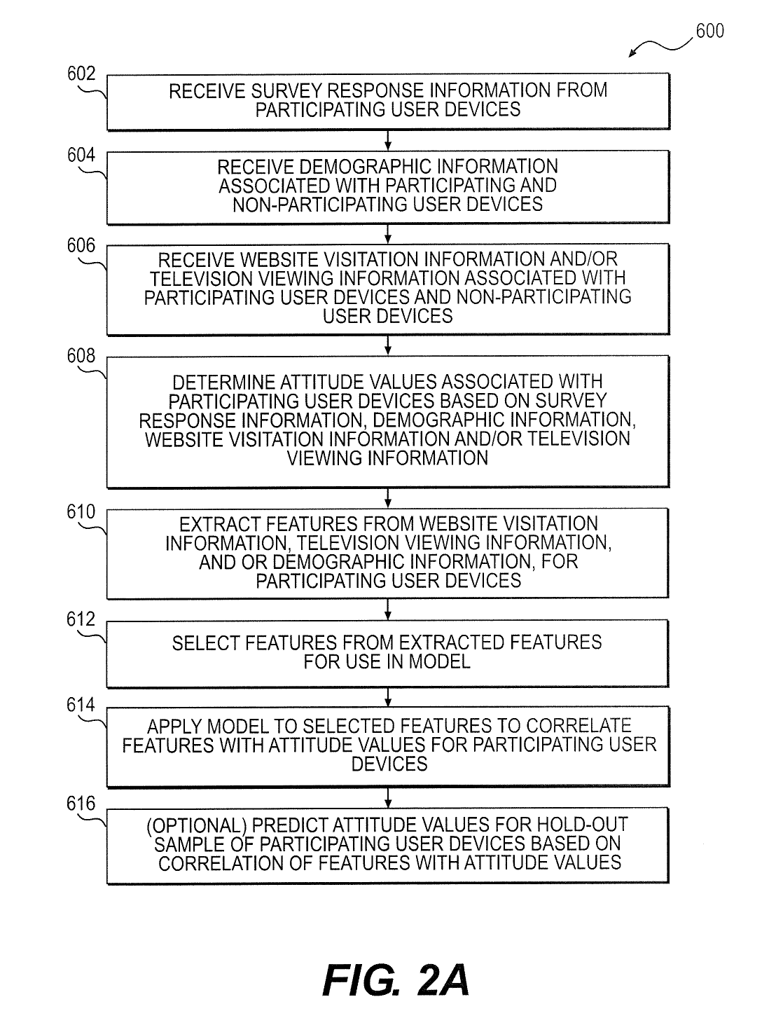

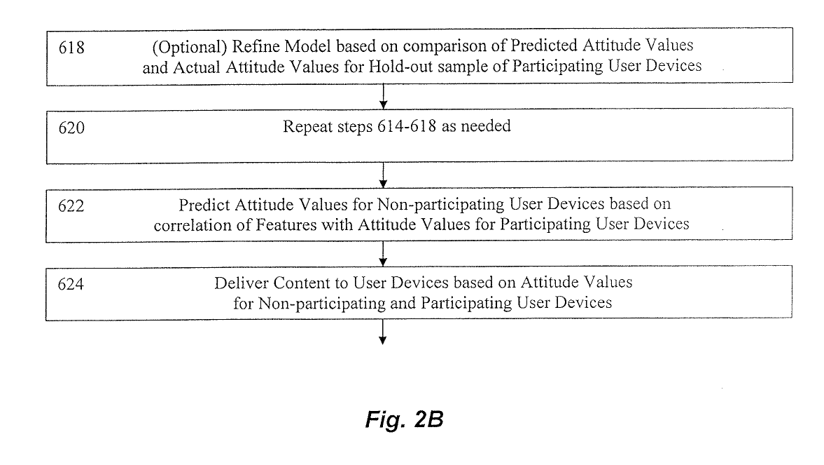

With reference to FIGS. 1, 2A and 2B, a method in accordance with an embodiment of the present invention may be carried out as follows. The method 600 may be used to deliver targeted content to individual user content delivery devices for display on the displays 302 connected to participating and/or non-participating user content delivery devices 300 and 306. The content may be targeted based on actual and predicted attitude values for participating and non-participating users.

With reference to FIG. 2A, in step 602 the participating users 304 may use the participating content delivery devices 300 to provide online survey response information 112 to the computer 100. The online survey response information 112 may be provided as the result of a participating user 304 using the associated participating content delivery device 300 to request the online survey, or as a result of the computer 100, or alternatively some other computer, directing an unsolicited online survey to a participating user device 300. The computer 100 may store the survey response information 112 in the first database 110, and associate the survey response information for a particular participating user 304 with an anonymous identifier for the particular participating user device 300 and/or the particular participating user 304.

Preferably, but not necessarily, survey response information 112 may be collected from at least 1,000 participating user devices 300, more preferably from at least 3,000 participating user devices, and most preferably from 4,500 or more participating user devices. It is also preferable to receive survey response information 112 from the participating user devices 300 over the course of multiple survey “waves” separated in time. Preferably, the survey “waves” are received more than a day apart, more preferably more than 30 days apart, and most preferably about three or more months apart. It is also preferable for the participating users 304 to provide survey response information 112 in response to more than two survey waves. The survey questions in each of the survey waves may be the same or different.

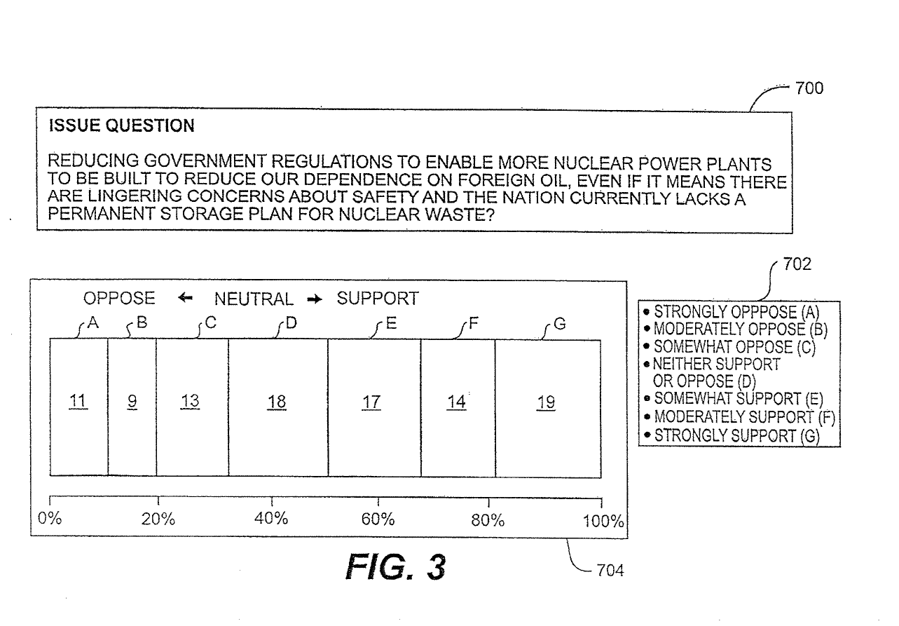

The survey response information 112 may be used to determine an attitude value for a participating user 304 either directly or indirectly. For example, with reference to FIG. 3, the survey response information 112 may include the responses of the participating users 304 to an issue question 700 concerning government regulation of nuclear power plants. The participating users 304 may use the participating user devices 300 to indicate their attitude about such regulation by selecting one of the attitudes provided in the menu 702 which range from “strongly oppose” to “strongly support.” The survey response information 112 for a particular issue may result in a tally 704 which is graphically represented in FIG. 3 to indicate the percentage number of participating users 304 who characterized themselves as having each of the corresponding attitudes. The survey response information 112 of each participating user 304 relating to each issue question 700 may be stored in the first database 110.

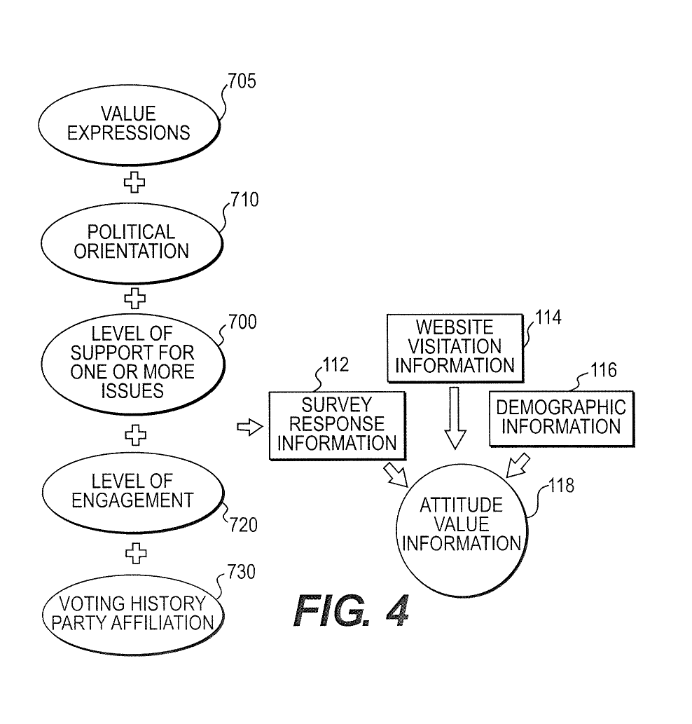

With reference to FIG. 4, in addition to answers to the issue questions 700, the survey response information 112 may further include answers to political orientation questions 710, level of engagement questions 720, and voting history/party affiliation questions 730, for example. Political orientation questions 710 are more general in character than issue questions 700. An example of an issue question is provided in FIG. 3, as compared with the following examples of political orientation questions 710:

Are you opposed to government regulation of business?

Are you opposed to government provided healthcare?

Examples of voting history/party affiliation questions 730 may include:

How often do you vote?

What elections do you normally participate in as a voter?

What political party or parties are you a member of?

The foregoing examples of issue questions 700, political orientation questions 710 and voting history/party affiliation questions 730 are intended to be illustrative and non-limiting of the intended scope of the present invention. It is appreciated that one or more of these types of questions (i.e., issue, political orientation, and voting history/party affiliation) may not be included in the survey response information 112 without departing from the intended scope of the present invention. Any type of question which will assist in determining the attitude of a user may be used.

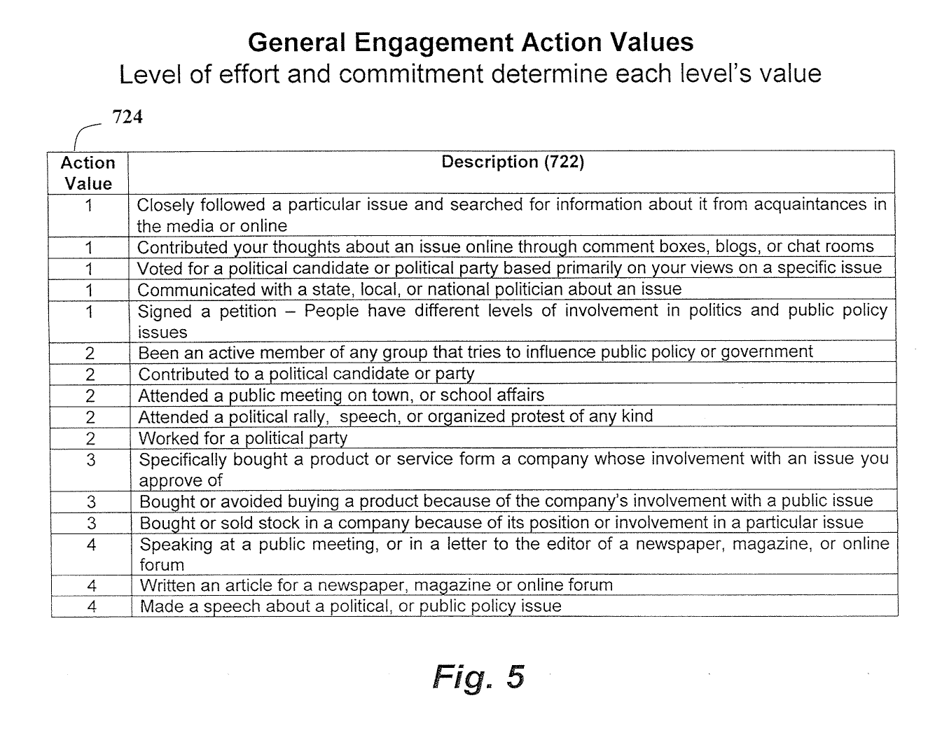

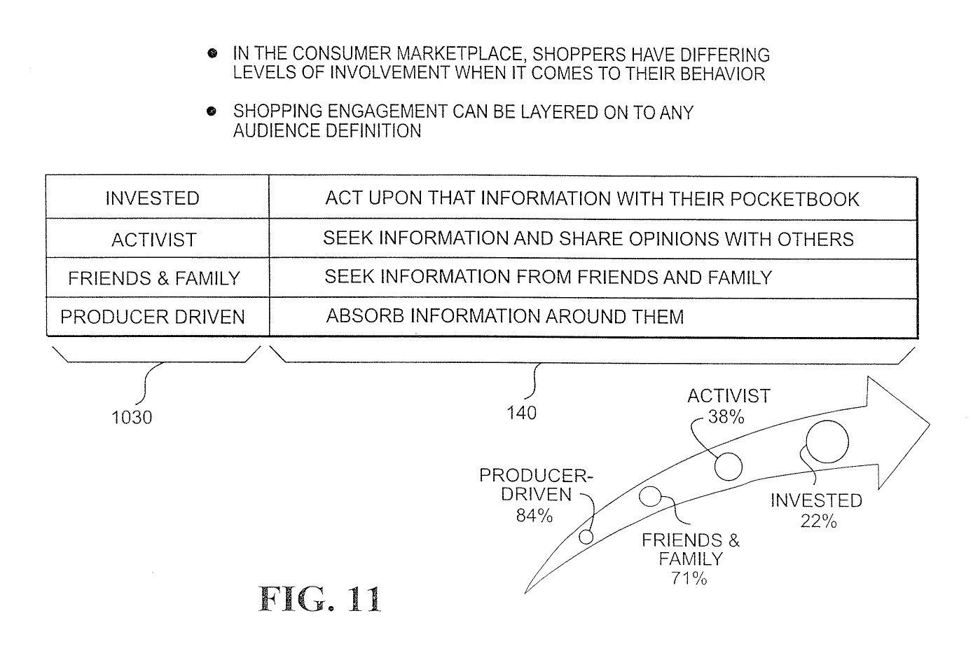

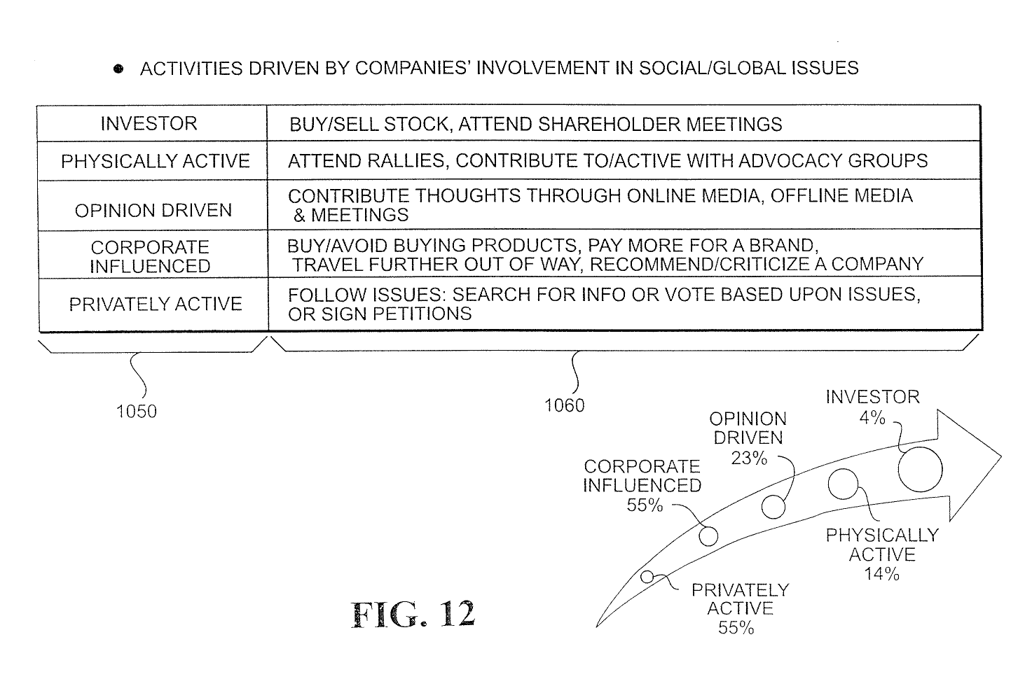

Additionally, level of engagement questions 720 which may be included in the survey response information 112 may be used to determine one or more level of engagement values for each participating user 304 on one or more engagement scales illustrated by FIGS. 5-9. The three engagement scales illustrated in FIGS. 5-9 are a general engagement scale, a political engagement scale, and an advocacy engagement scale. The number and type of engagement scales, as well as the associated definitions, levels and values used in connection with the scales are considered to be illustrative only and non-limiting of the invention which may be carried out without any engagement scales whatsoever. Alternative level of engagement scales are illustrated in FIGS. 11-12, for example.

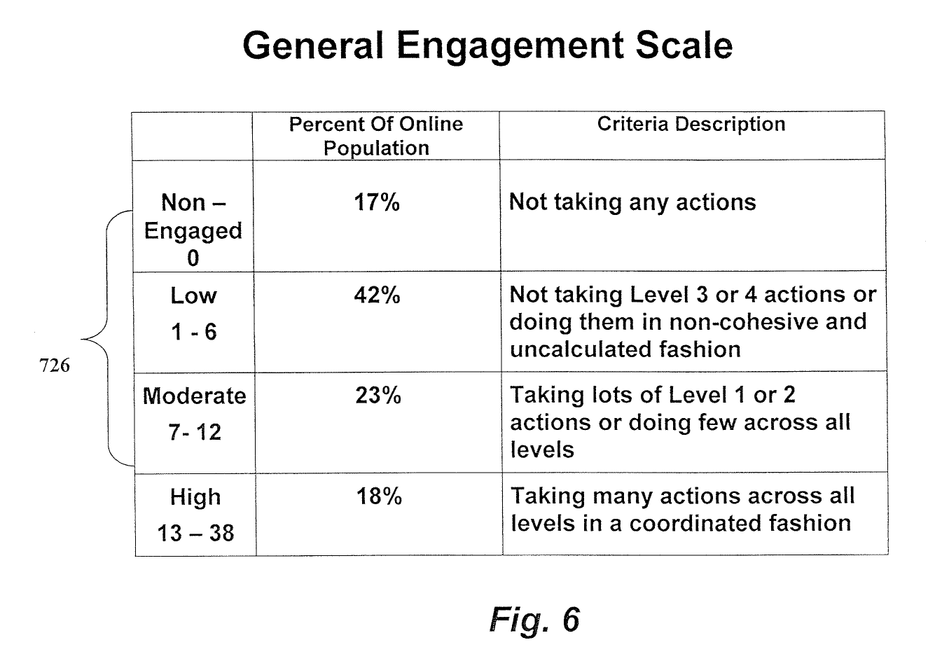

With reference to FIG. 5, the survey response information 112 may indicate that a particular participating user 304 has taken one or more of the general engagement actions 722 listed in FIG. 5. Each of the illustrative general engagement actions 722 may be associated with an action value shown in the left column of chart 724 by the computer 100. The computer 100 may compare the survey response information 112 for each participating user 304 with the actions 722 to determine the general engagement levels in the chart 726 shown in FIG. 6 that should be attributed to the participating user. The action values that the survey response information 112 indicates should be attributed to a participating user 304 may be added together by the computer 100 to aggregate a cumulative general engagement value. With reference to FIG. 6, each of four illustrative general engagement value ranges 726 are illustrated, ranging from “non-engaged” which is associated with a cumulative general engagement value of 0 to a “high” level of engagement associated with a cumulative general engagement value in the range of 13-38. The cumulative general engagement value for each participating user 304 may be stored by the computer 100 in the first database 110 in association with the anonymous identifier for the participating user.

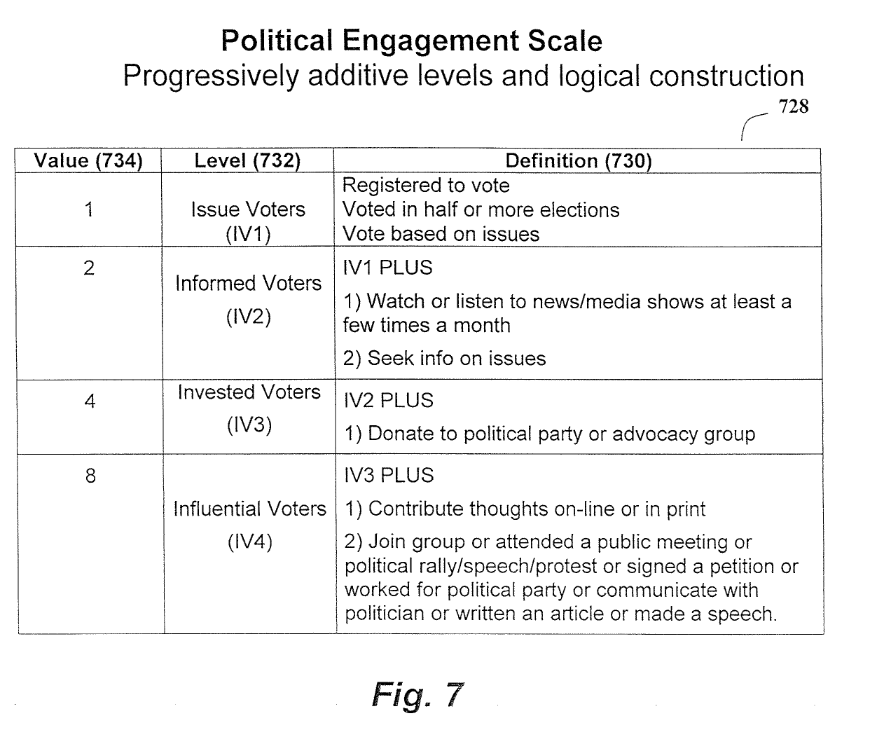

With reference to FIG. 7, the survey response information 112 may further indicate that a particular participating user 304 satisfies one or more of the political engagement definitions 730 shown in chart 728. Based on a comparison of the survey response information 112 with the definitions 730 by the computer 100, the participating user 304 may be associated with one of the political engagement levels 732 and associated political engagement values 734 on the illustrative political engagement scale. As indicated in the chart 728, the political engagement levels 732 and associated values 734 may be hierarchal such that a participating user 304 must satisfy the requirements of the preceding lower level in order to be eligible to satisfy the definition 730 of the next higher level. The political engagement value 734 for each participating user 304 may be associated with the anonymous identifier for the participating user by the computer 100 in the first database 110.

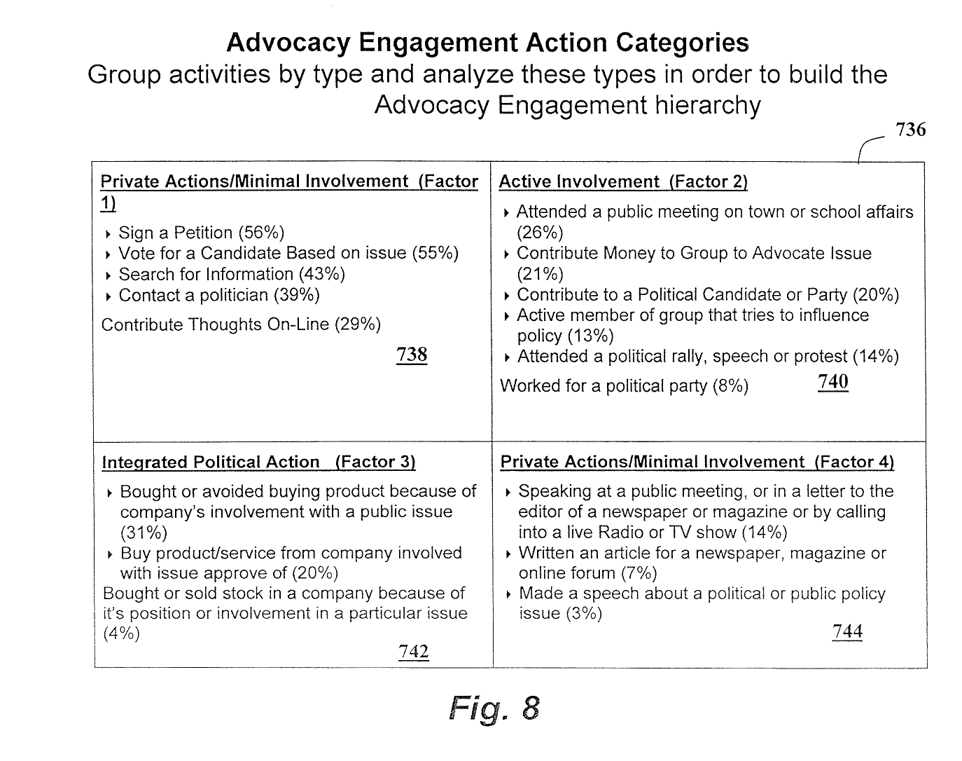

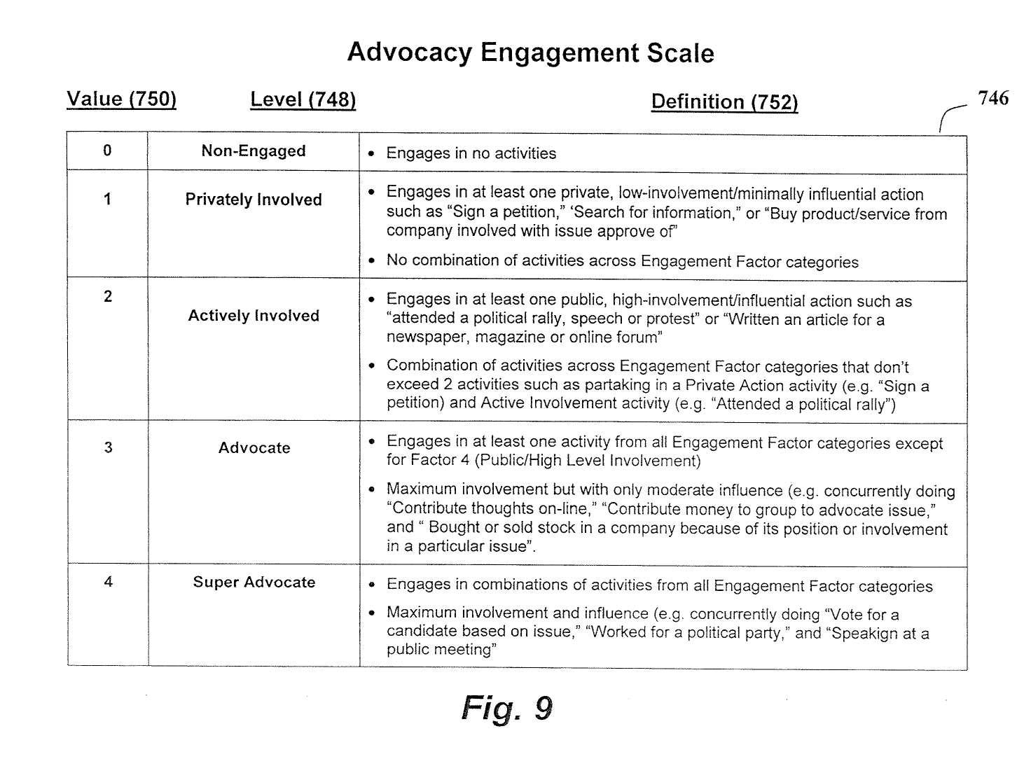

With reference to FIG. 8, the survey response information 112 may further indicate that a particular participating user 304 has taken one or more of the advocacy engagement actions shown in the chart 736. In the illustrative example shown, each advocacy engagement action may be placed in one of four groups: private actions 738, active involvement actions 740, integrated political actions 742, and public/high level involvement actions 744. With reference to FIGS. 8 and 9, a particular participating user 304 may be associated with one of the advocacy engagement levels 748 and corresponding advocacy engagement values 750 shown in the chart 746 based on a comparison implemented by the computer 100 between (i) the advocacy engagement actions indicated in the participating user's survey response information 112 and (ii) the advocacy engagement level descriptions 752. The advocacy engagement value 750 corresponding to the advocacy engagement level 748 that the participating user 304 qualifies for may be associated by the computer 100 with the anonymous identifier for the participating user in the first database 110.

With reference to FIGS. 6-9, one or more of the cumulative general engagement values 726, the political engagement values 734, and the advocacy engagement values 750 may be used in the determination of the attitude values 118 for each participating user. Determination of the attitude values 118 may be further based on website visitation and television viewing information 114 and/or demographic information 116. Preferably, the attitude value information 118 is determined from the combination of survey response information 112, the website visitation and/or television viewing information 116, and the demographic information 114 associated with the particular participating user device 300.

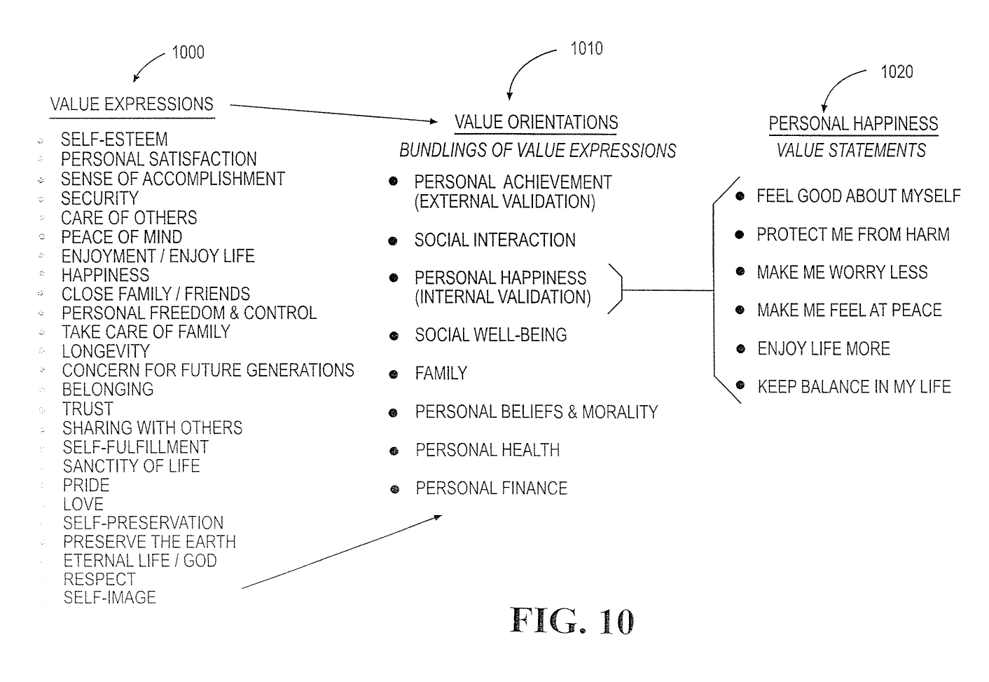

With reference to FIGS. 10-12, an attitude value may also be determined based in whole or in part on one or more of Value Orientation information, Purchase Category information, Purchase Orientation information, Brand Attribute information, Purchase Engagement information, Shopping Engagement information, and Corporate Involvement information, which are described above.

With reference to FIG. 10, Value Orientation information may be determined from the survey response information by the computer 100 running a statistical analysis of the survey response information to determine a numeric score, for example in the range of 1-5, for each of a number of Value Expressions 1000. The numeric score may indicate the importance of each Value Expression to a user.

The computer 100 may compare the Value Expression 1000 scores for the user with Value Expression score requirements associated with a number of Value Orientation Group 1010 definitions. The computer 100 may thus determine if the Value Expression scores qualify the user device 300 to have a low, medium or high affinity to one or more Value Orientation Groups 1010 based on this comparison. This affinity may comprise the Value Orientation information. The computer 100 may store information in the database 110 that indicates the affinity of the user device 300 with each Value Orientation Group 1010. The Value Orientation Groups 1010 may have Value Statements 1020 associated with each of them. The Value Orientation Groups 1010 may be used to determine characteristics of groups of user devices.

Purchase Category information may also be determined from the survey information. Purchase Category Groups may indicate Value Orientations for users for particular product or service types, such as food, clothing, home, etc. The computer 100 may compare the Value Expression scores for the user device 300 with Value Expression score requirements associated with a number of Purchase Category Group definitions. The computer 100 may determine if the Value Expression scores qualify the user device 300 to have a low, medium or high affinity to one or more Purchase Category Groups based on this comparison. This affinity level may comprise the Purchase Category information. The computer 100 may store information that indicates the affinity of the user device 300 with each Purchase Category Group.

For example, there may be six Purchase Category Groups which indicate a user device 300 affinity with Value Orientations as they pertain to nutritional foods, indulgence foods, things worn on a user's body, things that adorn a user's home, things displayed by a user in public, and services consumed by the user. The use of Purchase Category Groups may be used instead of Value Orientation Groups, as explained further below.

The survey response information may also be used to determine Purchase Orientation information for a user device 300 which indicates the relative importance of price, convenience (or accessibility), and brand for particular purchases. The relative importance of price, convenience and brand may be indicated by a numeric score or ranking and may be applied broadly across all purchases or applied to groups of purchases, such as those that comprise the Purchase Category Groups, for example. The Purchase Orientation information may be stored by the computer 100 in the first database 110.

With reference to FIGS. 1 and 11, the survey response information 112 may also be used to determine Shopping Engagement information in the form of the affinity of a user device 300 with one or more Shopping Engagement Groups 1030 for purchases overall or categories of purchases. The Shopping Engagement Groups 1030 may each be associated with shopping characteristics 1040. The level of shopping engagement may be determined by the computer 100 for each user device 300, which in turn may be used to determine the level of shopping engagement for any user definition or group. The level of shopping engagement may comprise the Shopping Engagement information which may be stored by the computer 100 in the first database 110. For example, the percentage of women aged 35-45 that fall into each of the four Shopping Engagement Groups 1030 shown in FIG. 11 may be determined by the computer 100.

With reference to FIG. 12, the survey response information 112 may also be used to determine Corporate Involvement information in the form of the affinity of a user device 300 with one or more Corporate Involvement Groups 1050, which may each be associated with corporate involvement characteristics 1060. The level of corporate involvement may be determined by the computer 100 for each user device 300 and for user groups or definitions. This Corporate Involvement information may be stored by the computer 100 in the first database 110.

The survey response information 112 may also be used to determine Brand Attribute information in the form of the affinity of a user device 300 with one or more brand characteristics and associated ratings, such as quality (e.g., high v. low), performance (e.g., best, good, poor), aesthetic impression (e.g., pleasing v. unpleasing), functionality (e.g., most v. least), innovativeness (e.g., most v. least), value (e.g., high v. low), luxuriousness (e.g., most v. least), easy of use (e.g., best v. worst), uniqueness (e.g., most v. least), and/or prestige (e.g., more v. less). Brand Attribute groups of users may be determined and associated with one or more Brand Attribute characteristics and associated ratings by the computer 100. The Brand Attribute information and Brand Attribute groups may be stored by the computer 100 in the first database 110.

The survey response information 112 may also include demographic information associated with the participating users 304. The participating user demographic information which is part of the survey response information 112 may include, without limitation, the following types of information: age, income, gender, census region, race, sexual orientation, education level, religious affiliation, frequency of attendance at religious services, union participation, frequency of Internet use information, hobbies, interests, personality traits and the like. It is appreciated that the foregoing list of demographic information is non-limiting and that embodiments of the present invention may utilize any types of demographic information that relates to users.

With renewed reference to FIG. 2A, in step 604 participating user demographic information 114 and non-participating user demographic information 142 may be received by the computer 100 for participating and/or non-participating users. The demographic information may be collected for the non-participating users 310 and the participating users 304 by the one or more third parties, or derived from other sources of online and/or offline information. The third parties may collect or derive the demographic information in any known manner, including, but not limited to tracking the online behavior of the non-participating users 310 and/or participating users 304. It is appreciated that the demographic information 114 and 142 which is associated with non-participating users 310 and/or associated with the participating users 304 may be collected by the host of the computer 100 instead of by one or more third parties in an alternative embodiment of the present invention. The demographic information may include Designated Market Area (DMA) code information and Prizm code information associated with a user and user device.

The demographic information pertaining to a particular user may be associated with the anonymous identifier for the participating user 304 in the first database 110 by the computer 100. Similarly, demographic information 14242 pertaining to a particular non-participating user may be associated with an anonymous identifier for the non-participating user 310 in the second database 140 by the computer 100. Further, the demographic information 114 may be provided multiple times, preferably at least once per wave, and more preferably at least once per month.

The demographic information 114, as it pertains to participating users 304, may be stored in the first database 110 so as to be associated with the same anonymous identifier used in connection with the survey response information 112. The demographic information 142, as it pertains to non-participating users 310, may not be specific to individual non-participating users, but instead descriptive of a large group of online user For example, the demographic information 142 as it pertains to non-participating users 310 may be collected for a number of users in a common geographic area, such as a Designated Market Area (DMA), or a number of users in any other group which may be characterized as having some common affiliation, such as political, economic, ethnic, racial, religious, age, gender, or the like. More specifically, in a preferred embodiment of the present invention, the demographic information 142 pertaining to non-participating users 310 may be received or stored such that it pertains to individual non-participating users defined by age ranges, gender, household income ranges, and census regions, etc.

With continued reference to FIGS. 1 and 2, in step 606, website visitation and/or television viewing information 116 and 144 pertaining to the participating user devices 300, and pertaining to the non-participating user devices 306, may be received by the computer 100. The website visitation and television viewing information 116 and 144 may be collected for the participating user devices 300 and the non-participating user devices 306 directly by the computer 100, or alternatively from the one or more third party computers 400 and/or associated databases 402.

While it is preferable to track such website visitation and/or television viewing information for all participating user devices 300 over a period of one to three months or more (i.e., a wave), it is appreciated that, without departing from the intended scope of the present invention, some participating user devices may “drop out” of the tracking process and therefore website visitation and/or television viewing information for such participating user devices may only be available over the course of more than one session, day, or week, as opposed to one to three months.

The website visitation and television viewing information 116 and 144 may be received by the first and second databases 110 and 140, respectively, from the computer 100 and stored therein. The tracking of the website visitation and television viewing information may be implemented by using software installed on participating and non-participating user content delivery devices 300 and 306, by cookies for tracking such information, or any other manner of tracking the online and/or television viewing behavior of a user. For example, third parties may provide website visitation and television viewing information.

With respect to the website visitation information, it may include, but is not necessarily limited to, website URL information, website channel visitation information, website page visitation information, session information, online purchase information, search term information, visitation timestamp, and duration information. A session or a visit to a website, is defined by the presence of a user with a specific IP address for a period of time (such as 30 minutes typically). Internet traffic metrics such as the number of unique visitors to a website, website channel, and/or website page during a time period (i.e., “unique visitors”), number of visits to a website, website channel, and/or website page during a time period (i.e., “visits”), number of website pages for a website that are viewed during a time period (i.e., “pages viewed”), and the number of minutes spent on a website during a time period, may be part of and/or derived from the website visitation information. A unique visitor to a website during a time period is defined as user device with distinct cookie ID or a distinct IP address that has visited the website one or more times during the time period. If user device visits the website more than once during the time period, the user device is still counted only as one unique visitor during the time period.

A website channel may fit hierarchically between a website and a website page. An example of a website is MSN.com, and an example of a website channel is the collection of website pages which are accessed from the “Sports” button on the MSN.com home page. References herein to a “website” are intended to be inclusive of a website in its entirety, a website channel, and a website page unless otherwise defined.

With respect to television viewing information, it may include without limitation: content type of a television program, amount of time spent watching a television channel, amount (i.e., volume) of time spent watching a television program or programming type, title of the television program, amount of time spent watching television programming of a particular content type, percentage share of overall viewing time spent watching one or more television channels, percentage share of overall viewing time spent watching one or more television programs, percentage share of overall viewing time spent watching television programming of a particular content type or different content types, a mode of content consumption, duration of viewing on a channel, number of channels viewed, degree of similarity between television programming viewed during a recent period and that viewed during a historical period, wherein said historical period includes time before said recent period, frequency with which the user changes television channels, actual display by a television of a particular television program, user interaction with a digital video recorder including details of such interaction, user interaction with an electronic programming guide including details of such interaction, user interaction with a video-on-demand (VOD) service including details of such interaction, keywords provided by the user or by an expert system, and time/date of viewing.

Details of user interaction with a DVR may include interactions such as recording, pausing, replaying, fast forwarding, and fast reversing, for example. Further, details of user interaction with an electronic programming guide may include interaction details such as duration of interaction, time and date of interaction, program detail information selected for review, and frequency of user interaction. And, details of user interaction with a VOD may include interactions such as duration of user interaction with the VOD service, time and date details of user interaction with the VOD service, and frequency of user interaction with the VOD service.

In step 608 of FIG. 2A, attitude values associated with the participating users 304 may be determined based on the survey response information 112 in combination with, or without, the demographic information 114 and the website visitation/television viewing information 116, as explained above in connection with FIGS. 3-12. Attitude values always take into account survey response information which indicates more than objective demographic, website visitation, and television viewing information and will, at least in part, indicate a user's subjective attitude, belief or value. For example, the difference between objective demographic information and a subjective attitude is apparent from the comparison of a user's age with a user's approval of nuclear power. A user cannot choose her age—it is an objective criteria which exists irrespective of the user's belief about her age. In contrast, a user may have any of a number of different attitudes with respect to nuclear power which are the product of the user's subjective thought process. Thus, as used in this application, attitude values always reflect, at least in part, a user's subjective thought. As explained above, these attitude values may indicate the users' political attitudes, legislative attitudes, regulatory attitudes, corporate attitudes, product attitudes, and/or any type of attitude.

In step 610, the computer 100 may extract the features (meaning website visitation information, television viewing information, and/or demographic information) associated with the participating user devices 300 which may be used to predict attitude values. For each data source, the computer 100 may determine which features are associated with a participating user device 300 that is also associated with one or more particular attitude values. The computer 100 may create a feature vector for each participating user device 300 by combining the features associated with each user device 300 for each data source.

In step 612, the computer 100 may select the features for use in predicting the attitude values to be associated with the non-participating user devices 306. The computer 100 may compare the extracted features to identify those features which are common to both the populations of the participating and non-participating user devices 300 and 306. For example, the computer 100 may identify which extracted websites have been visited by a statistically significant number of both participating and non-participating user devices. In another example, the computer 100 may identify which extracted television programs have been visited by a statistically significant number of both participating and non-participating user devices. In each such case, the computer 100 may select the feature categories for which there is sufficient data for both non-participating and participating user devices 300 and 306 to build a correlation between features and attitude values. For each of the common features, the computer 100 may determine a relevance score, including but not limited to correlation coefficient and Mutual information, between each selected feature and an attitude to be predicted. The computer 100 may analyze the distribution of relevance scores and set a relevance score threshold value which must be exceeded to keep the feature for use in the prediction process. In the feature selection process, the computer 100 may take into account the dimensionality of the feature vector to be used in the modeling, because to achieve high accuracy in prediction, high dimensionality may require a large amount of training data, i.e. more participating user devices. Final feature vectors which may be used to determine a correlation between a set of features and attitude values may then be created by the computer 100 based on the application of the relevance score thresholds.

In step 614, the computer 100 may apply the final feature vectors to a modeling algorithm to determine a correlation between a set of one or more features with one or more attitude values for the participating user devices 300. The algorithm used may be any of a number of supervised learning algorithms which is capable of mapping features (site visitation, etc.) to target labels (attribute values). For example, a Naïve Bayes, Neural Networks, Support Vector Machines, K-Nearest-Neighbor, Collaborative Filtering or Decision Tree/Random Forest model may be used. In an optional embodiment, the model may be applied to data associated with a population of participating user devices 300 which is less than all of such devices. In such case, the computer 100 may select some of the participating user devices 300 to be part of a hold-out sample of participating user devices.

In optional step 616, the computer 100 may apply the correlation determined in step 614 to the hold-out sample of participating user devices 300 to predict attitude values for the hold-out sample. The predicted attitude values may then be compared by the computer 100 with the actual attitude values for the hold-out sample. The computer may determine an estimated prediction accuracy for the predicted attitude values.

With reference to FIG. 2B, in optional step 618, the correlation model may then be modified and optimized to improve the estimated prediction accuracy In step 620, steps 614-618 may be repeated until an acceptable prediction accuracy results.

In step 622, which may follow step 614, or optionally, step 620, the model may be applied to the selected features associated with the non-participating user devices 306 to predict attitude values for non-participating user devices. The predicted attitude values for the non-participating user devices 306 may be stored in the second database 140. In step 624, targeted content may be delivered to the participating and non-participating user devices 300 and 306 based on the actual and predicted attitude values, respectively.

It will be apparent to those skilled in the art that variations and modifications of the present invention can be made without departing from the scope or spirit of the invention. For example, the particular attitudes which are of interest may be modified without departing from the intended scope of the invention. In addition, the models used to correlate attitude values and features may also be varied without departing from the intended scope of the invention.

What is claimed is:

1. A computer implemented method of transmitting content for viewing on a display connected to or incorporated into a content delivery device based on attitude values associated with the device, the method comprising:
receiving survey response information from participating user content delivery devices;
receiving features in the form of website visitation information associated with the (i) participating user content delivery devices, and (ii) non-participating user content delivery devices from which no survey response information is received;
determining attitude values associated with a plurality of said participating user content delivery devices based on the survey response information
correlating the attitude values associated with the plurality of participating user content delivery devices with one or more of the features associated with the plurality of participating user content delivery devices;
predicting attitude values for the non-participating user content delivery devices based on (i) one or more features associated with the non-participating user content delivery devices and (ii) the correlation of attitude values associated with the plurality of participating user content delivery devices with one or more of the features associated with the plurality of participating user content delivery devices; and
delivering content to one or more of the non-participating user content delivery devices based on the predicted attitude values.

2. The method of claim 1, further comprising the step of:
receiving features in the form of demographic information which is associated with the (i) plurality of participating user content delivery devices, and (ii) non-participating user content delivery devices.

3. The method of claim 2, further comprising the step of:
receiving features in the form of television viewing information which is associated with the (i) plurality of participating user content delivery devices, and (ii) non-participating user content delivery devices.

4. The method of claim 1, further comprising the step of:
receiving features in the form of television viewing information which is associated with the (i) plurality of participating user content delivery devices, and (ii) non-participating user content delivery devices.

5. The method of claim 1, further comprising the step of:
delivering content to the plurality of participating user content delivery devices based on the attitude values associated with the plurality of participating user content delivery devices.

6. The method of claim 1 associating in one or more databases the attitude value, the survey response information, and the website visitation information with an anonymous identifier for each of the plurality of participating user content delivery devices.

7. The method of claim 2, wherein the demographic information is selected from the group consisting of: age, income, gender, census region, race, education level, religious affiliation, frequency of attendance at religious services, union participation, and frequency of Internet use information.

8. The method of claim 1, wherein said website visitation information is selected from the group consisting of: website URL information, website page visitation information, session information, online purchase information, search term information, visitation time information, visitation duration information, and visitation date information.

9. The method of claim 1, wherein the survey response information is received from one of said plurality of participating user content delivery devices on two different days more than thirty days apart.

10. The method of claim 1, wherein the attitude value is determined based on one or more of: Value Orientation information, Purchase Category information, Purchase Orientation information, Brand Attribute information, Purchase Engagement information, Shopping Engagement information, and Corporate Involvement information.

11. The method of claim 1, wherein one or more of the plurality of participating user content delivery devices are associated with multiple attitude values.

12. The method of claim 1, wherein the website visitation information relates to at least a multiple session period.

13. The method of claim 12, wherein the multiple session period comprises a more than thirty day period.

14. The method of claim 1, further comprising the steps of:
receiving additional survey response information from additional participating user content delivery devices more than thirty days after the survey response information is received from the plurality of participating user content delivery devices; and
determining the attitude value for the plurality of participating and additional participating user content delivery devices based on the survey response information and the additional survey response information.

15. The method of claim 1, wherein the step of correlating the attitude values associated with the plurality of participating user content delivery devices with one or more features associated with the plurality of participating user content delivery devices further comprises the steps of:
determining attitude values for a hold-out sample of participating user content delivery devices;
predicting attitude values for the hold-out sample of participating user content delivery devices;
comparing the predicted attitude values for the hold-out sample of participating user content delivery devices with the determined attitude values for the hold-out sample of participating user content delivery devices to determine an estimated predictive accuracy for the predicted attitude values for the hold-out sample;
modifying a model used to correlate the attitude values associated with the plurality of participating user content delivery devices with one or more features associated with the plurality of participating user content delivery devices based on the estimated predictive accuracy ; and
re-correlating the attitude values associated with the plurality of participating user content delivery devices with one or more features associated with the plurality of participating user content delivery devices based on the modified model.

16. A computer implemented method of transmitting content for viewing on a display connected to or incorporated into a content delivery device based on attitude values associated with the device, the method comprising:
receiving survey response information from participating user content delivery devices;
receiving features in the form of demographic information which is associated with the (i) participating user content delivery devices, and (ii) non-participating user content delivery devices from which no survey response information is received;
determining attitude values associated with a plurality of said participating user content delivery devices based on the survey response information;
correlating the attitude values associated with the plurality of participating user content delivery devices with one or more of the features associated with the plurality of participating user content delivery devices;
predicting attitude values for the non-participating user content delivery devices based on (i) one or more features associated with the non-participating user content delivery devices and (ii) the correlation of attitude values associated with the plurality of participating user content delivery devices with one or more of the features associated with the plurality of participating user content delivery devices; and
delivering content to one or more of the non-participating user content delivery devices based on the predicted attitude values.

17. The method of claim 16, further comprising the step of:
receiving features in the form of television viewing information which is associated with the (i) plurality of participating user content delivery devices, and (ii) non-participating user content delivery devices.

18. The method of claim 16, further comprising the step of:
delivering content to the plurality of participating user content delivery devices based on the attitude values associated with the plurality of participating user content delivery devices.

19. The method of claim 16, further comprising the step of associating in one or more databases the attitude value, the survey response information, and the demographic information with an anonymous identifier for each of the plurality of participating user content delivery devices.

20. The method of claim 16, wherein the demographic information is selected from the group consisting of: age, income, gender, census region, race, education level, religious affiliation, frequency of attendance at religious services, union participation, and frequency of Internet use information.

21. The method of claim 16, wherein the survey response information is received from one of said plurality of participating user content delivery devices on two different days more than thirty days apart.

22. The method of claim 16, wherein the attitude value is determined based on one or more of: Value Orientation information, Purchase Category information, Purchase Orientation information, Brand Attribute information, Purchase Engagement information, Shopping Engagement information, and Corporate Involvement information.

23. The method of claim 16, wherein one or more of the plurality of participating user content delivery devices are associated with multiple attitude values.

24. The method of claim 17, wherein the television viewing information relates to at least a multiple session period.

25. The method of claim 24, wherein the multiple session period comprises a more than thirty day period.

26. The method of claim 16, further comprising the steps of:
receiving additional survey response information from additional participating user content delivery devices more than thirty days after the survey response information is received from the plurality of participating user content delivery devices; and
determining the attitude value for the plurality of participating and additional participating user content delivery devices based on the survey response information and the additional survey response information.

27. The method of claim 16, wherein the step of correlating the attitude values associated with the plurality of participating user content delivery devices with one or more features associated with the plurality of participating user content delivery devices further comprises the steps of:
determining attitude values for a hold-out sample of participating user content delivery devices;
predicting attitude values for the hold-out sample of participating user content delivery devices;
comparing the predicted attitude values for the hold-out sample of participating user content delivery devices with the determined attitude values for the hold-out sample of participating user content delivery devices to determine an estimated predictive accuracy for the predicted attitude values for the hold-out sample;
modifying a model used to correlate the attitude values associated with the plurality of participating user content delivery devices with one or more features associated with the plurality of participating user content delivery devices based on the estimated predictive accuracy; and
re-correlating the attitude values associated with the plurality of participating user content delivery devices with one or more features associated with the plurality of participating user content delivery devices based on the modified model.

28. A computer implemented method of transmitting content for viewing on a display connected to or incorporated into a content delivery device based on attitude values associated with the device, the method comprising:
receiving survey response information from participating user content delivery devices;
receiving features in the form of television viewing information which is associated with the (i) participating user content delivery devices, and (ii) non-participating user content delivery devices from which no survey response information is received;
determining attitude values associated with a plurality of said participating user content delivery devices based on the survey response information;
correlating the attitude values associated with the plurality of participating user content delivery devices with one or more of the features associated with the plurality of participating user content delivery devices;
predicting attitude values for the non-participating user content delivery devices based on (i) one or more features associated with the non-participating user content delivery devices and (ii) the correlation of attitude values associated with the plurality of participating user content delivery devices with one or more of the features associated with the plurality of participating user content delivery devices; and
delivering content to one or more of the non-participating user content delivery devices based on the predicted attitude values.

29. The method of claim 28, further comprising the step of:
delivering content to the plurality of participating user content delivery devices based on the attitude values associated with the plurality of participating user content delivery devices.

30. The method of claim 28, further comprising the step of associating in one or more databases the attitude value, the survey response information, and the demographic information with an anonymous identifier for each of the participating user content delivery devices.

31. The method of claim 28, wherein the demographic information is selected from the group consisting of: age, income, gender, census region, race, education level, religious affiliation, frequency of attendance at religious services, union participation, and frequency of Internet use information.

32. The method of claim 28, wherein the survey response information is received from one of said plurality of participating user content delivery devices on two different days more than thirty days apart.

33. The method of claim 28, wherein the attitude value is determined based on one or more of: Value Orientation information, Purchase Category information, Purchase Orientation information, Brand Attribute information, Purchase Engagement information, Shopping Engagement information, and Corporate Involvement information.

34. The method of claim 28, wherein one or more of the plurality of participating user content delivery devices are associated with multiple attitude values.

35. The method of claim 28, wherein the television viewing information relates to at least a multiple session period.

36. The method of claim 35, wherein the multiple session period comprises a more than thirty day period.

37. The method of claim 28, further comprising the steps of:
receiving additional survey response information from additional participating user content delivery devices more than thirty days after the survey response information is received from the plurality of participating user content delivery devices; and
determining the attitude value for the plurality of participating and additional participating user content delivery devices based on the survey response information and the additional survey response information.

38. The method of claim 28, wherein the step of correlating the attitude values associated with the plurality of participating user content delivery devices with one or more features associated with the plurality of participating user content delivery devices further comprises the steps of:
determining attitude values for a hold-out sample of participating user content delivery devices;
predicting attitude values for the hold-out sample of participating user content delivery devices;
comparing the predicted attitude values for the hold-out sample of participating user content delivery devices with the determined attitude values for the hold-out sample of participating user content delivery devices to determine an estimated predictive accuracy for the predicted attitude values for the hold-out sample;
modifying a model used to correlate the attitude values associated with the plurality of participating user content delivery devices with one or more features associated with the plurality of participating user content delivery devices based on the estimated predictive accuracy; and
re-correlating the attitude values associated with the plurality of participating user content delivery devices with one or more features associated with the plurality of participating user content delivery devices based on the modified model.
